(19) United States
(12) Patent Application Publication
(10) Pub. No.: US 2025/0142474 A1
(43) Pub. Date: May 1, 2025

(54) SYSTEM AND METHOD FOR WAKEUP SIGNAL DESIGN TO FACILITATE ULTRA-LOW POWER RECEPTION

(71) Applicant: Huawei Technologies Co., Ltd., Shenzhen (CN)

(72) Inventors: Qian Cheng, Naperville, IL (US); Weimin Xiao, Hoffman Estates, IL (US); Zhigang Rong, San Diego, CA (US); Jialing Liu, Palatine, IL (US)

(21) Appl. No.: 19/009,659

(22) Filed: Jan. 3, 2025

Related U.S. Application Data
(63) Continuation of application No. PCT/US2023/026971, filed on Jul. 6, 2023.
(60) Provisional application No. 63/389,227, filed on Jul. 14, 2022.

(51) Int. Cl. H04W 52/02

(52) U.S. Cl. CPC H04W 52/0229

(57) ABSTRACT

According to embodiments, a user equipment (UE) using a first radio of the UE receives from a base station one or more configurations. The one or more configurations indicate resources allocated to wakeup signal (WUS) transmission. The UE using a second radio of the UE detects a WUS in the resources while the first radio of the UE is in a sleep power state. The UE using the first radio performs a wakeup procedure with the base station.

### PRIORITY CLAIM AND CROSS-REFERENCE

This patent application is a continuation of PCT/US2023/026971 filed on Jul. 6, 2023, and entitled “System and Method for Wakeup Signal Design to Facilitate Ultra-Low Power Reception,” which claims priority to U.S. Provisional Application No. 63/389,227, filed on Jul. 14, 2022, and entitled “System and Method for Wakeup Signal Design to Facilitate Ultra-Low Power Reception,” applications of which are hereby incorporated by reference herein as if reproduced in their entireties.

### TECHNICAL FIELD

The present disclosure relates generally to wireless communications and, in particular embodiments, to techniques and mechanisms for wakeup signal design to facilitate ultra-low power reception.

### BACKGROUND

To reduce the power consumption of a device (e.g., an Internet of Things (IoT) device), it is helpful to put the device into deep sleep as much as possible when the device is idle, so the device may wake up to receive and transmit information when needed. During the deep sleep, the device may monitor some type of wake-up signal (WUS), replacing paging early indication (PEI), with as low power consumption as possible.

### SUMMARY

Technical advantages are generally achieved, by embodiments of this disclosure which describe methods and apparatus for wakeup signal design to facilitate ultra-low power reception.

According to embodiments, a UE using a first radio of the UE receives from a base station one or more configurations. The one or more configurations indicate resources allocated to wakeup signal (WUS) transmission. The UE using a second radio of the UE detects a WUS in the resources while the first radio of the UE is in a sleep power state. The UE using the first radio performs a wakeup procedure with the base station.

In some embodiments, after receiving the one or more configurations, the UE may configure the second radio of the UE based on the one or more configurations. For the UE to configure the second radio, a controller inside or outside the first radio may configure the second radio based on the one or more configurations. In an embodiment, the first radio may forward the one or more configurations to the second radio. The first radio of the UE may transition to the sleep power state. After detecting the WUS, the second radio of the UE may wake up the first radio of the UE.

In some embodiments, the resources may include one or more WUS resource blocks (WU-RBs). The one or more configurations may indicate a frequency location, a time duration, a starting position, and a periodicity for the WUS. The one or more WU-RBs may be in a WUS bandwidth part (WUS-BWP). A first number of tones carrying the WUS may be based on a second number of the one or more WU-RBs and a one-sided fraction of bandwidth used for bandpass filter bandage roll-off.

In some embodiments, the one or more configurations may further indicate at least one of a bit-level repetition number or a block-level repetition number for the WUS.

In some embodiments, the one or more configurations may further indicate a subcarrier spacing (SCS) for the WUS in a carrier. The SCS may be different from a second SCS used for data and control signal transmissions in the carrier. The SCS may be one of 60 kHz, 120 kHz, 240 kHz, 480 kHz, or 960 kHz, and wherein the resources are within frequency range 1 (FR1).

In some embodiments, the WUS may be modulated by on-off keying (OOK). The one or more configurations may indicate one or more sequences for shaping an on waveform for the WUS. The one or more sequences may be cell specific or receiver specific. The one or more sequences may be one or more Zadoff-Chu (ZC) sequences.

In some embodiments, the one or more configurations may be carried in a radio resource control (RRC) message or in a system information block (SIB).

In some embodiments, the UE using the first radio may transmit a configuration acknowledgement acknowledging the one or more configurations.

In some embodiments, the UE using the first radio may communicate with the base station in response to the wakeup procedure.

In some embodiments, the first radio may be a main radio of the UE. The second radio may be a wake-up receiver (WUR) of the UE.

According to embodiments, a base station transmits to a first radio of a user equipment (UE), one or more configurations. The one or more configurations indicate resources allocated to wakeup signal (WUS) transmission. The base station transmits to a second radio of the UE, a WUS in the resources while the first radio of the UE is in a sleep power state. The base station performs a wakeup procedure with the first radio of the UE.

In some embodiments, the resources may include one or more WUS resource blocks (WU-RBs). The one or more configurations may indicate a frequency location, a time duration, a starting position, and a periodicity for the WUS. The one or more WU-RBs may be in a WUS bandwidth part (WUS-BWP). A first number of tones carrying the WUS may be based on a second number of the one or more WU-RBs and a one-sided fraction of bandwidth used for bandpass filter bandage roll-off.

In some embodiments, the one or more configurations may further indicate at least one of a bit-level repetition number or a block-level repetition number for the WUS.

In some embodiments, the one or more configurations may further indicate a subcarrier spacing (SCS) for the WUS in a carrier. The SCS may be different from a second SCS used for data and control signal transmissions in the carrier. The SCS may be one of 60 kHz, 120 kHz, 240 kHz, 480 kHz, or 960 kHz, and wherein the resources are within frequency range 1 (FR1).

In some embodiments, the WUS may be modulated by on-off keying (OOK). The one or more configurations may indicate one or more sequences for shaping an on waveform for the WUS. The one or more sequences may be cell specific or receiver specific. The one or more sequences may be one or more Zadoff-Chu (ZC) sequences.

In some embodiments, the one or more configurations may be carried in a radio resource control (RRC) message or in a system information block (SIB).

In some embodiments, the base station may receive from the first radio of the UE, a configuration acknowledgement acknowledging the one or more configurations.

In some embodiments, the base station may communicate with the first radio of the UE in response to the wakeup procedure.

In some embodiments, the first radio may be a main radio of the UE. The second radio may be a wake-up receiver (WUR) of the UE.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example communications system 100, according to some embodiments;

FIG. 1B shows an example of the wake-up receiver (WUR) for receiving the OOK modulated WUS, according to some embodiments;

FIG. 2 shows an example WUS-RB 200, according to some embodiments;

FIG. 3 shows an example block diagram of the transmitter, according to some embodiments;

FIG. 4 shows an example base sequence, according to some embodiments;

FIG. 5 shows an example base sequence, according to some embodiments;

FIG. 6 shows an example base sequence, according to some embodiments;

FIG. 7 shows an example base sequence, according to some embodiments;

FIG. 8 illustrates bit block repetition, according to some embodiments;

FIG. 9 shows an example of coded bits level repetition, according to some embodiments;

FIG. 10 shows an example of coded bits level repetition, according to some embodiments;

FIG. 11 shows an example flow chart for WUS configurations, transmission, and receptions, according to some embodiments;

FIG. 12A illustrates a flow chart of a method performed by a UE, according to some embodiments;

FIG. 12B illustrates a flow chart of a method performed by a base station, according to some embodiments;

FIG. 13 illustrates an embodiment communication system;

FIGS. 14A and 14B illustrate example devices that may implement the methods and teachings according to this disclosure;

FIG. 15 shows a block diagram of a computing system that may be used for implementing the devices and methods disclosed herein, according to some embodiments; and

FIGS. 16A-16E illustrates wake-up signal evaluation results. Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

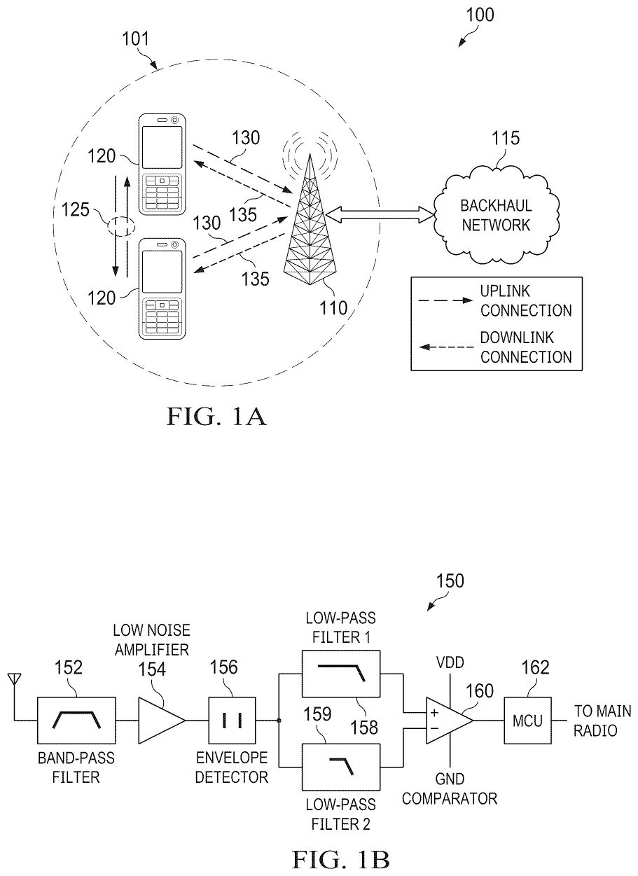

FIG. 1A illustrates an example communications system 100, according to embodiments. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1A, the sidelink communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links from the UE to the access node are referred to as uplinks 130, and the communication links from the access node to the UE are referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

5G systems are designed and developed for both mobile telephony and vertical use cases. Besides latency, reliability, and availability, UE energy efficiency is also critical to 5G. Currently, 5G devices may have to be recharged per week or day, depending on the individual's usage time. In general, 5G devices consume tens of milliwatts in RRC idle/inactive state and hundreds of milliwatts in RRC connected state. Designs to prolong battery life are desired for improving energy efficiency as well as for better user experience. Devices supporting the sleep power state can be even more energy efficient. The sleep power state can include the sleep states defined in the current standard discussions, such as “light sleep,” “microsleep,” “deep sleep,” and “ultra-deep sleep.” Each state denotes that the UE shuts down certain components (e.g., hardware subsystems in the UE). Table 1 below shows the On/Off statuses of the components corresponding to the deep sleep, light sleep, and microsleep states. For the ultra-deep sleep state, all components listed in Table 1 are off. These sleep states consume even less energy. For example, a device in the deep sleep state consumes less than 1*3 milliwatts, and a device in the ultra-deep sleep state consumes less than 0.015*3 milliwatts.

TABLE 1

| Hardware | Latency for | | | |
|---|---|---|---|---|
| subsystem | OFF<->ON | Deep sleep | Light sleep | Microsleep |
| Crystal | Medium | Off | On | On |
| oscillator (XO) | | | | |
| RF/front-end | Low | Off | Off | Off (partial) |
| Baseband | Medium | Off | On | On |
| modem | | | | |
| Control | High | Low power | Active | Active |
| processor | | | | |
| DDR memory | Very high | Low power | Active | Active |
| | | (Self-refresh | | |
| | | mode) | | |

Energy efficiency is even more desirable for UEs without a continuous energy source (e.g., UEs using small rechargeable and single coin cell batteries). Among vertical use cases, sensors and actuators are deployed extensively for monitoring, measuring, and/or charging, etc. Normally, the batteries of sensors and actuators are not rechargeable and are expected to last at least a few years. Wearables include smart watches, rings, eHealth related devices, and medical monitoring devices. With typical battery capacity, it is technically challenging to sustain up to 1-2 weeks for the wearables.

The power consumption of a device depends on the configured length of wake-up periods (e.g., paging cycle). To meet the battery life requirements described above, the extended discontinuous reception (eDRX) cycle with a large cycle duration value is expected to be used, resulting in high latency, which is not suitable for services with requirements of both long battery life and low latency. For example, in fire detection and extinguishment use cases, fire shutters shall be closed and fire sprinklers shall be turned on by the actuators within 1 to 2 seconds from the time the fire is detected by sensors; long eDRX cycle cannot meet the delay requirements. eDRX is apparently not suitable for latency-critical use cases. Thus, the intention is to study ultra-low power mechanisms that can support low latency in Rel-18, e.g. lower than eDRX latency.

Currently, a UE needs to periodically wake up once per DRX cycle, which dominates the power consumption in periods with no signaling or data traffic. If the UE is able to wake up only when the UE is triggered (e.g., paging), power consumption could be dramatically reduced. This can be achieved by using a wake-up signal to trigger the main radio and a separate receiver (e.g., a wake-up receiver) which has the ability to monitor wake-up signals with ultra-low power consumption. The main radio works for transmissions and receptions of data/control channels, which can be turned off or set to deep sleep unless it is turned on.

The power consumption for monitoring wake-up signal depends on the wake-up signal design and the hardware module of the wake-up receiver (WUR) used for signal detecting and processing.

The low-power WUS/WUR for power-sensitive, small form-factor devices including IoT use cases (such as industrial sensors, controllers) and wearables may be targeted. Other use cases are not precluded (e.g., XR/smart glasses, smart phones).

As opposed to the work on UE power savings in previous releases, existing signals to be used as a WUS are not required. All WUS solutions identified are able to operate in a cell supporting legacy UEs. Solutions may target substantial gains compared to the existing Rel-15/16/17 UE power saving mechanisms. Other aspects such as detection performance, coverage, UE complexity, may be covered.

In Machine-type communication (MTC), MTC wake-up signal (MWUS) is specified to help the receiver avoiding wasting power on trying to decode MTC physical downlink control channel (MPDCCH). MPDCCH decoding may be performed only when MWUS is detected, thus reducing the power consumption. The targeted MWUS receiver is based on sequence correlation detection, which means that the normal receiver components (e.g., RF chain, digital baseband receiver and, etc.) are still operational during the detection process. Thus, the saving on power consumption from MWUS is limited and cannot meet ultra-low power reduction requirements. To achieve the ultra-low power, it is typical to use passive circuit receivers at the RF front-end. In that case, only energy detection may be performed at the RF front-end. An on-off keying (OOK) type of modulation usually works well in generating signal for energy detection types of receivers. The detection output is the input to the micro controller unit (MCU) for further digital domain processing. The processing result determines whether the wake-up signal is targeted at this receiver and if indeed it is the case, corresponding operations and procedures will be performed. FIG. 1B shows an example of the wake-up receiver (WUR) 150 for receiving the OOK modulated WUS, according to some embodiments. The example WUR 150 in FIG. 1B includes a band-pass filter 152, a low noise amplifier 154, an envelope detector 156, a first low-pass filter 158, a second low-pass filter 159, a comparator 160, and an MCU 162.

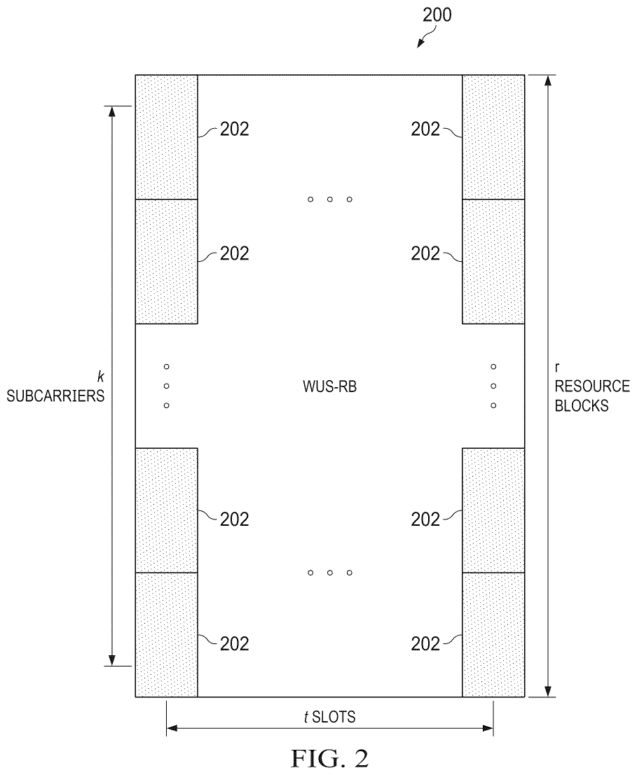

To co-exist with current 5G physical channels and signals, the network configures one or more bandwidth parts (BWP) dedicated to the transmission of the wakeup signal (WUS-BWP) on one or more carriers. The one or more carriers may be either dedicated to WUS (i.e., only WUS-BWP may be configured on a carrier) or used by both WUS and non-WUS communications. Within the allocated WUS-BWP, a set of resource blocks (RBs) are grouped together to form the time-frequency resources for wakeup signal transmission. The set of RBs could be called the wakeup signal resource block (WUS-RB) or wakeup signal resource range (WUS-RG). FIG. 2 shows an example WUS-RB 200, according to some embodiments. The WUS-RB 200 in FIG. 2 may consist of r contiguous RBs in the frequency domain and span t contiguously multiple slots or orthogonal frequency-division multiplexing (OFDM) symbols in the time domain to form a large contiguous time-frequency resource block. The WUS-RB 200 may include resources 202 that can serve as guard bands and guard intervals. The WUS-RB 200 carrying wakeup signal targeting different receivers (e.g., UEs, wireless sensors and wearables) could be multiplexed in the frequency and time domain. The WUS-BWP configurations, including the frequency location, time duration, starting position, and periodicity, along with the WUS-RB allocation for wakeup transmission within the WUS-BWP may be signaled to the receiver through RRC for each UE.

The WUS-BWP configuration and the WUS-RB allocation within the BWP for wakeup signal transmission may also be pre-defined (e.g., according to the deployment frequency band). The targeted wakeup receiver may get the detailed configurations and allocations from a lookup table.

Less restriction on the subcarrier spacing (SCS) used within the WUS-BWP may be supported to facilitate the timely transmission of the wakeup signal. For example, assuming the deployment band of the network is within frequency range 1 (FR1), according to the conventional solution, the possible SCS configurations are 15 kHz and 30 kHz. While for WUS-BWP, more SCSs (e.g., 60 kHz, 120 kHz, 240 kHz or even 480 kHz, and 960 kHz) may also be used. The network can transmit the wakeup signal within the WUS-BWP according to the configured SCS regardless of deployed frequency band. For another example, if the deployment band of the network is within frequency range 2 (FR2), according to the conventional solution, the possible SCS configurations are 60 kHz, 120 kHz, and 240 KHz. While for WUS-BWP, more SCSs (e.g., 15 kHz, 30 kHz, or even 7.5 kHz and 5 kHz) may also be used.

Any SCS specified in the conventional solution could be used for WUS-BWP regardless of the frequency band the network operates on. The SCS used in the WUS-BWP could be signaled to the wakeup receiver through RRC or predefined (e.g., according to the network operating band).

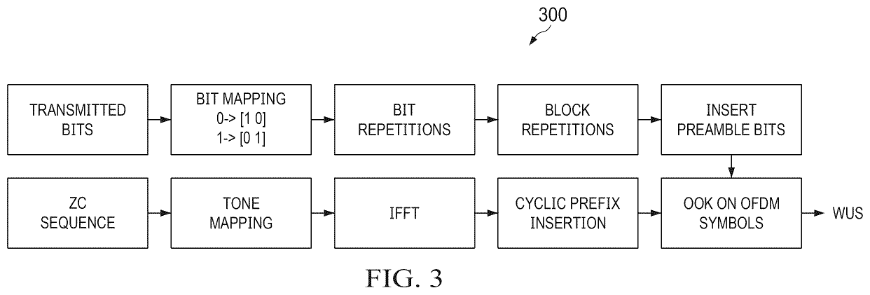

FIG. 3 shows an example block diagram of the transmitter 300, according to some embodiments. The details of some the blocks are provided in this disclosure.

Two parameters determine the subcarriers for a wakeup signal's actual transmission: (1) the number of RBs along the frequency domain of the WUS-RB, and (2) the roll-off factor for bandpass filter band edge.

Assume the WUS-RB has r RBs along the frequency domain. Further, assume f_{BP} indicates a guard band width. In some embodiments, f_{BP} may be the one-sided fraction of the portion of the allocated bandwidth as the guard band to satisfy the bandpass filter roll-off requirement. Then, the number of subcarriers k, used to carry a wakeup signal is

$$k = 12 r - 2 \cdot ⌈ 12 r \cdot {f}_{BP} ⌉$$

The k subcarriers for actual wakeup signal transmission occupy the middle subcarriers of the WUS-RB. In some example embodiments described in this disclosure, it may be assumed that the number of subcarriers per RB is 12. Other values of the number of subcarriers per RB (e.g., 24 and 36 etc.) are possible.

In another embodiment, f_{BP} may be the fraction of the bandwidth carrying the wakeup signal. So, the number of subcarriers k used to carry wakeup signal is

$$k = ⌊ 12 r \cdot {f}_{BP} ⌋$$

In yet another embodiment, f_{BP} may be defined as the total fraction of the portion of the allocated bandwidth as the guard band to satisfy the bandpass filter roll-off requirement, the number of subcarriers k used to carry the wakeup signal is

$$k = 12 r - ⌈ 12 r \cdot {f}_{BP} ⌉$$

Assume the subcarrier indexes within the WUS-RB are 0, 1, 2, . . . , 12r-1, then the k subcarriers used to carry wakeup signal are the ones with indices

$$⌊ ( 12 r - k ) / 2 ⌋ , ⌊ ( 12 r - k ) / 2 ⌋ + 1 , … , ⌊ ( 12 r - k ) / 2 ⌋ + k - 1$$

The symbols transmitted on the k subcarriers could be binary phase-shift keying (BPSK) or quadrature phase shift keying (QPSK) modulated. The mapping from bit sequence to modulated symbols may reuse the same one as performed for other reference signals (e.g., phase tracking reference signal (PTRS), demodulation reference signal (DMRS), etc.). The bit sequence may be random sequence generated with specific initialization according to the combination of cell ID, UE ID, slot, and OFDM symbol indexes, etc. An example is to reuse the latest DMRS sequence generating configuration which is signaled to UE through high-layer messages.

For detection algorithms based on RF signal envelope energies, the peak to average power ratio (PAPR) may play an important role in detection performance. To reduce WUS PAPR, the network may consider transmit low PAPR symbol sequence on the k subcarriers. One example is to transmit Zadoff-Chu (ZC) sequence. ZC sequence is well known for its correlation properties and constant amplitude. If the number of subcarriers, k, does not happen to be a prime number which is the typical ZC sequence length used in specification, cyclic extension or truncation may be applied on the prime-numbered ZC sequence to make it have the length of k.

To further reduce the PAPR and hence improve the detection performance, the network may transmit WUS on less than k subcarriers. For example, assume the greatest prime number not greater than k is p, the network may only transmit WUS on the p subcarriers. The indexes of subcarrier carrying WUS can be calculated as:

$$⌊ ( 12 r - p ) / 2 ⌋ , ⌊ ( 12 r - p ) / 2 ⌋ + 1 , … , ⌊ ( 12 r - p ) / 2 ⌋ + p - 1$$

Table 2 is an example of the actual number of subcarriers A which carry the WUS. f_{BP} is the one-sided fraction of bandwidth used for bandpass filter band edge roll-off. The values of r, f_{BP}, k, and p may be signaled to the UE through higher-layer messages.

TABLE 2

| r | f_{BP} = 0.05 | | f_{BP} = 0.1 | |
|---|---|---|---|---|
| (RB) | k | p | k | p |
| 1 | 10 | 7 | 8 | 7 |
| 2 | 20 | 19 | 18 | 17 |
| 3 | 32 | 31 | 28 | 23 |
| 4 | 42 | 41 | 38 | 37 |
| 5 | 54 | 53 | 48 | 47 |
| 6 | 64 | 61 | 56 | 53 |

The generation of the ZC sequence may reuse the same parameter configurations as for the physical uplink control channel (PUCCH) or physical uplink shared channel (PUSCH) DMRS. So, the generation of the ZC sequence may reuse the latest sequence generating configuration (e.g., group hopping and sequence hopping parameters), which is signaled to UE through high-layer messages.

The random sequence or the ZC sequence, mentioned above, could be specific to the targeted receiver or cell specific. The basic ZC sequence of length k could be generated using the following equation

$$r ( n ) = {x}_{q} ( n mod p ) \\ {x}_{q} ( m ) = {e}^{- j \frac{- π qm ( m + 1 )}{p}}$$

The number p is given by the largest prime number such that p is smaller or equal to the number of subcarriers k used to transmit the WUS. q is a parameter related to the identity of the cell transmitting the WUS. If p is less than k, cyclic extension may be applied on the prime-numbered ZC sequence to make it to the length of k.

ZC sequence is also specified in the MWUS for MTC. There are differences between the ZC sequence for MWUS and the embodiment WUS for ultra-low power consumption. First, the target receiver and receiving operation are different. Because the MWUS is designed assuming the receiver performs sequence correlation detection, the ZC sequence was chosen due to its excellent correlation properties. While in the embodiment solutions for ultra-low power WUS, energy detection is expected at the receiver, the ZC sequence is to improve the receiving performance by reducing the signal PAPR. Second, the ZC sequence is transmitted in 2 PRBs in the MWUS design and on every tone of these 2 PRBs. In the embodiment solutions, the ZC sequence could be transmitted using a configurable number of PRBs, and it is not necessary to occupy every tone of the allocated PRB(s) to further reduce the signal PAPR.

Another embodiment technique to transmit the WUS in a cell specific way is to transmit a portion of the continuous subcarriers used in a primary synchronization signal (PSS) or secondary synchronization signal (SSS) transmission. The specific portion used by the WUS may be pre-defined or by implementation.

The power from the unused subcarriers at the edge of the allocated PRB(s) could be allocated to the WUS carrying subcarriers to boost its transmission power.

An alternative embodiment technique is to generate the WUS signal in the time domain directly using a low PAPR waveform of the frequency bandwidth within the assigned BWP or PRBs for the WUS.

The information carried by the WUS may be modulated by on-off keying (OOK). The on and off operations are operated on the granularity of OFDM symbol level. For example, a WUS OFDM symbol may be turned completely off to indicate one bit of information (e.g., bit 0). On the other hand, the signal transmission may be present in one OFDM symbol duration to indicate the other information (e.g., bit 1). The opposite mapping between On/Off and bit 0/1 may also be specified.

A sequence of bits may be mapped to one WUS transmission. Each bit in the sequence is sequentially mapped to one OFDM symbol duration. The content of the bit determines whether the WUS should be transmitted within the corresponding OFDM symbol duration. Upon being specified, a bit 0 may mean no transmission of the signal and a bit 1 means transmission of the signal in the OFDM symbol duration, and vice versa.

The bit sequence can include two parts: preamble bits and coded bits. The preamble bits are present at the beginning of the WUS transmission. The purpose of the preamble part of the WUS is to let the WUS receiver adjust its automatic gain control (AGC) and warm up its bandpass and lowpass filters which are desirable for proper WUS detection.

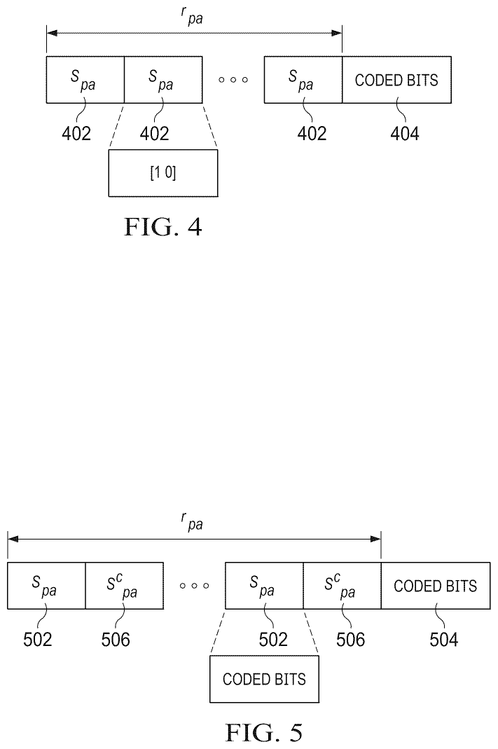

The preamble sequence may include several repetitions of certain base sequences Sₚₐ. The number of repetitions, rₚₐ, is signaled by network through an RRC message before the UE enters the RRC-inactive state. The number rₚₐ could also be predefined (e.g., in a lookup table according to the network deployment band). The choice of rₚₐ should be large enough for the receiver to finish warming up its AGC and filters. One example of the base sequence is Sₚₐ 402 (Sₚₐ=[1 0]) in FIG. 4, according to some embodiments. If the first coded bit of the coded bits 404 is 0, Sₚₐ=[0 1] may be used for preamble to have the 1->0 transition at the beginning of the transmission of the coded bits 404.

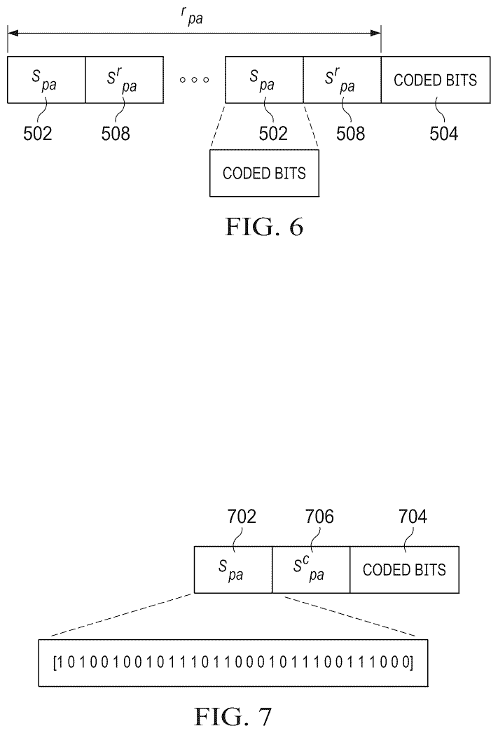

Another embodiment example of the base sequence Sₚₐ is the coded bits (e.g., 504 in FIG. 5) itself. A special case in this example is that the preamble sequence may be [Sₚₐ Sₚₐ^{c}] where Sₚₐ^{c} 506 is the bit-wise complementary of Sₚₐ 502 bits in FIG. 5, according to some embodiments. Another special case in this example is that the preamble sequence is [Sₚₐ Sₚₐ^{c}] where Sₚₐ^{c} 508 is the time reversed version of Sₚₐ 502 bits in FIG. 6, according to some embodiments.

If the coded bits are more than just a fixed bit sequence corresponding to the identity of the targeted wake up receiver (e.g., the code bits 704 may contain a network signaling message to the receiver), the preamble sequence may also need to carry the synchronization functionality. For example, the designed sequence may be transmitted as the preamble (e.g., including Sₚₐ 702 and/or Sₚₐ^{c} 706) to achieve good synchronization performance as shown in FIG. 7, according to some embodiments.

The coded bits may be generated by mapping the information bits, which comprise the receiver identity information or/and network signaling bits, into the WUS bit stream to transmit. One example of the mapping may be: bit 0 is mapped to bits stream [1 0] and bit 1 is mapped to bits stream [0 1] or vice versa. The mapping may also be controlled by the parameter r_{b}, which determines the mapping bits repetitions. Assume that r takes different values of 1, 2 and 3, the corresponding bit mapping would be: Bit 0 is mapped to bit streams [1 0], [1 1 0 0] and [1 1 1 0 0 0], respectively, bit 1 is mapped to bit streams [0 1], [0 0 1 1] and [0 0 0 1 1 1], respectively. The bit repetition is useful in scenario where the SCS is large and the wireless channel path delay is extensive. The reason is that for the shorter OFDM symbol duration and the longer wireless channel path delay, more signal energy from previous on duration leaks into the off duration of OOK modulated OFDM symbols which could degrade the detection performance.

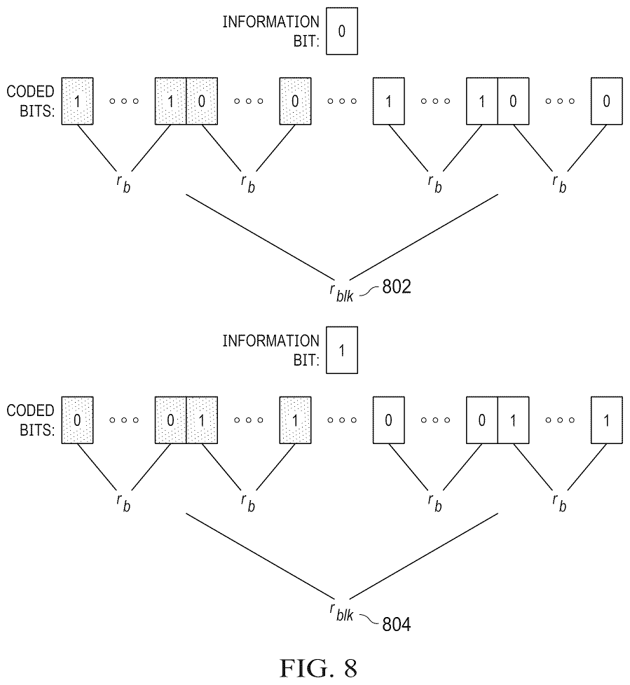

On top of the bit repetition, there may be additional bit block repetition r_{blk} (e.g., r_{blk} 802 and r_{blk} 804), which repeats the entire bit block to enhance the WUS detection performance as shown in FIG. 8, according to some embodiments.

The r_{b} and r_{blk} parameters may be configured independently. The order of repetition is to perform bit level repetition r_{b} firstly if any, then the bit block level repetition row secondly. For example, in the case of configuration rb=2 and r_{blk}=1, the mapping becomes: Bit 0 is mapped to bit streams [1 1 0 0], bit 1 is mapped to bit streams [0 0 1 1]. In other case of configuration r_{b}=1 and r_{blk}=2, the mapping becomes: bit 0 is mapped to bit streams [1 0 1 0], bit 1 is mapped to bit streams [0 1 0 1]. In another case of configuration r_{b}=2 and r_{blk}=2, the mapping becomes: Bit 0 is mapped to bit streams [1 1 0 0 1 1 0 0], bit 1 is mapped to bit streams [0 0 1 1 0 0 1 1].

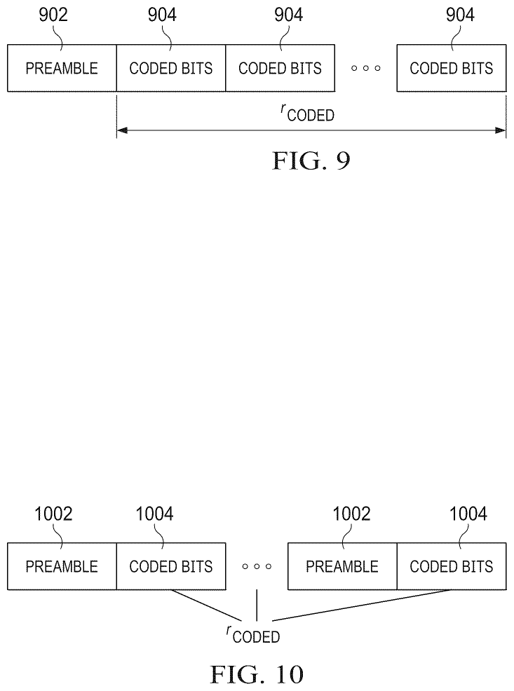

After the entire information bits have been mapped into coded bits, additional coded bits level repetition, r_{coded}, may apply. When the repetition is contiguous in time, only the coded bit stream 904 may be repeated as shown FIG. 9, according to some embodiments. As shown in FIG. 9, the preamble bit stream 902 is not repeated. If the repetition is not continuous in time, the entire preamble bit stream 1002 and coded bit stream 1004 are repeated r_{coded} times as shown in FIG. 10, according to some embodiments.

The parameters, r_{b}, r_{blk} and r_{coded} may be signaled to the receiver through RRC message or predefined (e.g., in a lookup table depending on the network operating band).

The network may try to avoid transmitting the WUS which contains the first OFDM symbol at the beginning of a half subframe. The first OFDM symbol has the duration longer than the other OFDM symbols, which may create synchronization issue and degrade the detection performance of WUS receiver. For the case that preamble does not carry the synchronization functionality, the preamble may contain the first OFDM symbol with a longer duration.

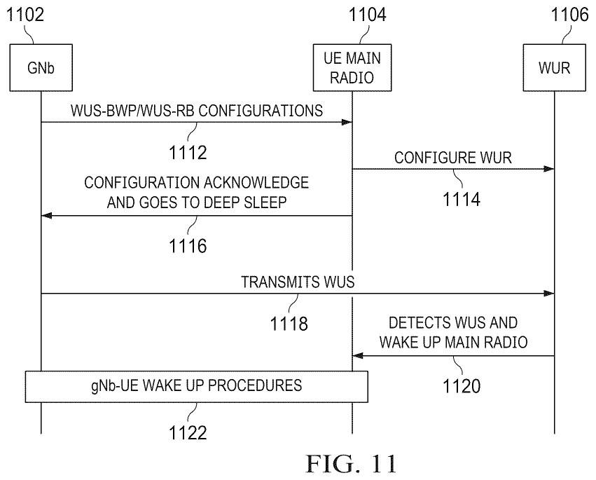

FIG. 11 shows an example flow chart 1100 for WUS configurations, transmission, and receptions between the gNB 1102, the UE main radio 1104, and the UE WUR 1106, according to some embodiments. The main radio 1104 of the UE is the radio for normal communications of data/control channels using protocols such as LTE or new radio (NR) communication. To turn off main radio 1104 of the UE is to suspend all normal LTE or NR transmissions and reception of data channels, control channels, and signals. To wake up the main radio 1104 is equivalent to transitioning the UE from the deep sleep mode (where the UE only receives wakeup signals or any other type of signals that can be received by the WUR 1106 of the UE, for example to wake up the main radio 1104) to another state where the UE can start receiving (including detecting and/or decoding) from the network node in the downlink LTE or NR synchronization signal/PBCH block (SSB), reference signals (e.g., tracking reference signal (TRS), CSI reference signal (CSI-RS)), control channels (e.g., physical downlink control channel (PDCCH)), data channels (e.g., physical downlink shared channel (PDSCH)), paging signals, etc., or combination of them, and where the UE can start transmitting in the uplink LTE or NR random access channel (RACH) signals, control channels (e.g., PUCCH), data channels (e.g., PUSCH), reference signals (e.g., sounding reference signal (SRS)), etc., or combination of them.

At the operation 1112, the main radio 1104 of the UE receives from the gNB 1102 one or more configurations. The one or more configurations configure one or more BWPs or one or more RBs dedicated to WUS transmission.

At the operation 1114, the main radio 1104 of the UE configures a WUR 1106 of the UE based on the one or more configurations.

At the operation 1116, the main radio 1104 of the UE transmits a configuration acknowledgement acknowledging the one or more configurations to the gNB 1102. The main radio 1104 of the UE transitions to deep sleep.

At the operation 1118, the gNB transmits a WUS to the WUR 1106 of the UE.

At the operation 1120, the WUR 1106 of the UE detects the WUS transmitted by the gNB 1102 over the one or more BWPs or the one or more RBs dedicated to WUS transmission. The WUR 1106 of the UE wakes up the main radio 1104 of the UE.

At the operation 1122, the main radio 1104 of the UE performs a wakeup procedure with the gNB 1102.

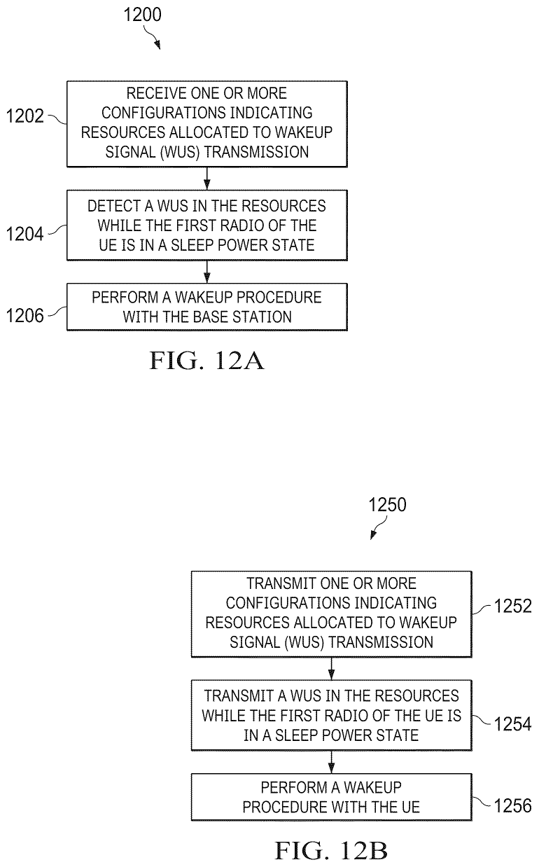

FIG. 12A illustrates a flow chart of a method 1200 performed by a UE, according to some embodiments. The UE may include computer-readable code or instructions executing on one or more processors of the UE. Coding of the software for carrying out or performing the method 1200 is well within the scope of a person of ordinary skill in the art having regard to the present disclosure. The method 1200 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 1200 starts at the operation 1202, where the UE using a first radio of the UE receives from a base station one or more configurations. The one or more configurations indicate resources allocated to wakeup signal (WUS) transmission. At the operation 1204, the UE using a second radio of the UE detects a WUS in the resources while the first radio of the UE is in a sleep power state. At the operation 1206, the UE using the first radio performs a wakeup procedure with the base station.

In some embodiments, after receiving the one or more configurations, the UE may configure the second radio of the UE based on the one or more configurations. For the UE to configure the second radio, a controller inside or outside the first radio may configure the second radio based on the one or more configurations. In an embodiment, the first radio may forward the one or more configurations to the second radio. The first radio of the UE may transition to the sleep power state. After detecting the WUS, the second radio of the UE may wake up the first radio of the UE.

In some embodiments, the resources may include one or more WUS resource blocks (WU-RBs). The one or more configurations received in operation 1202 may indicate a frequency location, a time duration, a starting position, and a periodicity for the WUS. The one or more WU-RBs may be in a WUS bandwidth part (WUS-BWP). A first number of tones carrying the WUS may be based on a second number of the one or more WU-RBs and a bandwidth portion of the resources used for bandpass filter bandage roll-off. The bandwidth portion may be represented as f_{BP}, which can be defined using any of the examples described above, for example.

In some embodiments, the one or more configurations may further indicate at least one of a bit-level repetition number or a block-level repetition number for the WUS.

In some embodiments, the one or more configurations may further indicate a subcarrier spacing (SCS) for the WUS in a carrier. The SCS may be different from a second SCS used for data and control signal transmissions in the carrier. The SCS may be one of 60 kHz, 120 kHz, 240 kHz, 480 kHz, or 960 kHz, and wherein the resources are within frequency range 1 (FR1).

In some embodiments, the WUS may be modulated by on-off keying (OOK). The one or more configurations may indicate one or more sequences for shaping an “on” waveform of the OOK for the WUS. The one or more sequences may be cell specific or receiver specific. The one or more sequences may be one or more Zadoff-Chu (ZC) sequences.

In some embodiments, the one or more configurations may be carried in a radio resource control (RRC) message or in a system information block (SIB).

In some embodiments, the UE using the first radio may transmit a configuration acknowledgement acknowledging the one or more configurations.

In some embodiments, the UE using the first radio may communicate with the base station in response to the wakeup procedure.

In some embodiments, the first radio may be a main radio of the UE. The second radio may be a wake-up receiver (WUR) of the UE.

FIG. 12B illustrates a flow chart of a method 1250 performed by a base station, according to some embodiments. The base station may include computer-readable code or instructions executing on one or more processors of the base station. Coding of the software for carrying out or performing the method 1250 is well within the scope of a person of ordinary skill in the art having regard to the present disclosure. The method 1250 may include additional or fewer operations than those shown and described and may be carried out or performed in a different order. Computer-readable code or instructions of the software executable by the one or more processors may be stored on a non-transitory computer-readable medium, such as for example, the memory of the base station.

The method 1250 starts at the operation 1252, where the base station transmits to a first radio of a user equipment (UE), one or more configurations. The one or more configurations indicate resources allocated to wakeup signal (WUS) transmission. At the operation 1254, the base station transmits to a second radio of the UE, a WUS in the resources while the first radio of the UE is in a sleep power state. At the operation 1256, the base station performs a wakeup procedure with the first radio of the UE.

In some embodiments, the resources may include one or more WUS resource blocks (WU-RBs). The one or more configurations may indicate a frequency location, a time duration, a starting position, and a periodicity for the WUS. The one or more WU-RBs may be in a WUS bandwidth part (WUS-BWP). A first number of tones carrying the WUS may be based on a second number of the one or more WU-RBs and a bandwidth portion of the resources used for bandpass filter bandage roll-off. The bandwidth portion may be represented as f_{BP} described above.

In some embodiments, the one or more configurations may further indicate at least one of a bit-level repetition number or a block-level repetition number for the WUS.

In some embodiments, the one or more configurations may further indicate a subcarrier spacing (SCS) for the WUS in a carrier. The SCS may be different from a second SCS used for data and control signal transmissions in the carrier. The SCS may be one of 60 kHz, 120 kHz, 240 kHz, 480 kHz, or 960 kHz, and wherein the resources are within frequency range 1 (FR1).

In some embodiments, the WUS may be modulated by on-off keying (OOK). The one or more configurations may indicate one or more sequences for shaping an on waveform for the WUS. The one or more sequences may be cell specific or receiver specific. The one or more sequences may be one or more Zadoff-Chu (ZC) sequences.

In some embodiments, the one or more configurations may be carried in a radio resource control (RRC) message or in a system information block (SIB).

In some embodiments, the base station may receive from the first radio of the UE, a configuration acknowledgement acknowledging the one or more configurations.

In some embodiments, the base station may communicate with the first radio of the UE in response to the wakeup procedure.

In some embodiments, the first radio may be a main radio of the UE. The second radio may be a wake-up receiver (WUR) of the UE.

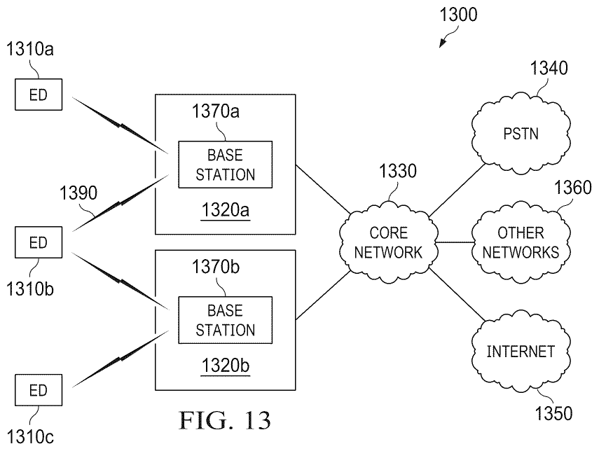

FIG. 13 illustrates an example communication system 1300. In general, the system 1300 enables multiple wireless or wired users to transmit and receive data and other content. The system 1300 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1300 includes electronic devices (ED) 1310a-1310c, radio access networks (RANs) 1320a-1320b, a core network 1330, a public switched telephone network (PSTN) 1340, the Internet 1350, and other networks 1360. While certain numbers of these components or elements are shown in FIG. 13, any number of these components or elements may be included in the system 1300.

The EDs 1310a-1310c are configured to operate or communicate in the system 1300. For example, the EDs 1310a-1310c are configured to transmit or receive via wireless or wired communication channels. Each ED 1310a-1310c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1320a-1320b here include base stations 1370a-1370b, respectively. Each base station 1370a-1370b is configured to wirelessly interface with one or more of the EDs 1310a-1310c to enable access to the core network 1330, the PSTN 1340, the Internet 1350, or the other networks 1360. For example, the base stations 1370a-1370b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1310a-1310c are configured to interface and communicate with the Internet 1350 and may access the core network 1330, the PSTN 1340, or the other networks 1360.

In the embodiment shown in FIG. 13, the base station 1370a forms part of the RAN 1320a, which may include other base stations, elements, or devices. Also, the base station 1370b forms part of the RAN 1320b, which may include other base stations, elements, or devices. Each base station 1370a-1370b operates to transmit or receive wireless signals within a particular geographic region or area, sometimes referred to as a “cell.” In some embodiments, multiple-input multiple-output (MIMO) technology may be employed having multiple transceivers for each cell.

The base stations 1370a-1370b communicate with one or more of the EDs 1310a-1310c over one or more air interfaces 1390 using wireless communication links. The air interfaces 1390 may utilize any suitable radio access technology.

It is contemplated that the system 1300 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1320a-1320b are in communication with the core network 1330 to provide the EDs 1310a-1310c with voice, data, application, Voice over Internet Protocol (VoIP), or other services. Understandably, the RANs 1320a-1320b or the core network 1330 may be in direct or indirect communication with one or more other RANs (not shown). The core network 1330 may also serve as a gateway access for other networks (such as the PSTN 1340, the Internet 1350, and the other networks 1360). In addition, some or all of the EDs 1310a-1310c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1350.

Although FIG. 13 illustrates one example of a communication system, various changes may be made to FIG. 13. For example, the communication system 1300 could include any number of EDs, base stations, networks, or other components in any suitable configuration.

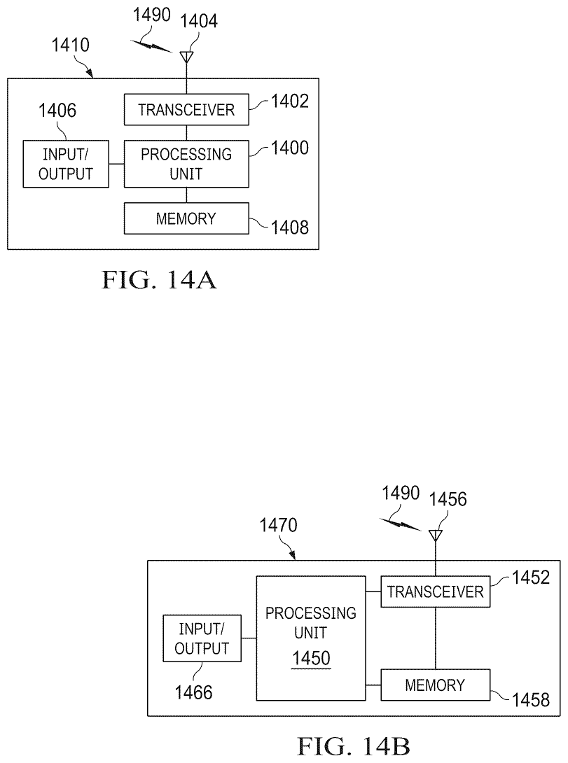

FIGS. 14A and 14B illustrate example devices that may implement the methods and teachings according to this disclosure. In particular, FIG. 14A illustrates an example ED 1410, and FIG. 14B illustrates an example base station 1470. These components could be used in the system 1300 or in any other suitable system.

As shown in FIG. 14A, the ED 1410 includes at least one processing unit 1400. The processing unit 1400 implements various processing operations of the ED 1410. For example, the processing unit 1400 could perform signal coding, data processing, power control, input/output processing, or any other functionality enabling the ED 1410 to operate in the system 1000. The processing unit 1400 also supports the methods and teachings described in more detail above. Each processing unit 1400 includes any suitable processing or computing device configured to perform one or more operations. Each processing unit 1400 could, for example, include a microprocessor, microcontroller, digital signal processor, field programmable gate array, or application specific integrated circuit.

The ED 1410 also includes at least one transceiver 1402. The transceiver 1402 is configured to modulate data or other content for transmission by at least one antenna or NIC (Network Interface Controller) 1404. The transceiver 1402 is also configured to demodulate data or other content received by the at least one antenna 1404. Each transceiver 1402 includes any suitable structure for generating signals for wireless or wired transmission or processing signals received wirelessly or by wire. Each antenna 1404 includes any suitable structure for transmitting or receiving wireless or wired signals. One or multiple transceivers 1402 could be used in the ED 1410, and one or multiple antennas 1404 could be used in the ED 1410. Although shown as a single functional unit, a transceiver 1402 could also be implemented using at least one transmitter and at least one separate receiver.

The ED 1410 further includes one or more input/output devices 1406 or interfaces (such as a wired interface to the Internet 1350). The input/output devices 1406 facilitate interaction with a user or other devices (network communications) in the network. Each input/output device 1406 includes any suitable structure for providing information to or receiving information from a user, such as a speaker, microphone, keypad, keyboard, display, or touch screen, including network interface communications.

In addition, the ED 1410 includes at least one memory 1408. The memory 1408 stores instructions and data used, generated, or collected by the ED 1410. For example, the memory 1408 could store software or firmware instructions executed by the processing unit(s) 1400 and data used to reduce or eliminate interference in incoming signals. Each memory 1408 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 14B, the base station 1470 includes at least one processing unit 1450, at least one transceiver 1452, which includes functionality for a transmitter and a receiver, one or more antennas 1456, at least one memory 1458, and one or more input/output devices or interfaces 1466. A scheduler, which would be understood by one skilled in the art, is coupled to the processing unit 1450. The scheduler could be included within or operated separately from the base station 1470. The processing unit 1450 implements various processing operations of the base station 1470, such as signal coding, data processing, power control, input/output processing, or any other functionality. The processing unit 1450 can also support the methods and teachings described in more detail above. Each processing unit 1450 includes any suitable processing or computing device configured to perform one or more operations. Each processing unit 1450 could, for example, include a microprocessor, microcontroller, digital signal processor, field programmable gate array, or application specific integrated circuit.

Each transceiver 1452 includes any suitable structure for generating signals for wireless or wired transmission to one or more EDs or other devices. Each transceiver 1452 further includes any suitable structure for processing signals received wirelessly or by wire from one or more EDs or other devices. Although shown combined as a transceiver 1452, a transmitter and a receiver could be separate components. Each antenna 1456 includes any suitable structure for transmitting or receiving wireless or wired signals. While a common antenna 1456 is shown here as being coupled to the transceiver 1452, one or more antennas 1456 could be coupled to the transceiver(s) 1452, allowing separate antennas 1456 to be coupled to the transmitter and the receiver if equipped as separate components. Each memory 1458 includes any suitable volatile or non-volatile storage and retrieval device(s). Each input/output device 1466 facilitates interaction with a user or other devices (network communications) in the network. Each input/output device 1466 includes any suitable structure for providing information to or receiving/providing information from a user, including network interface communications.

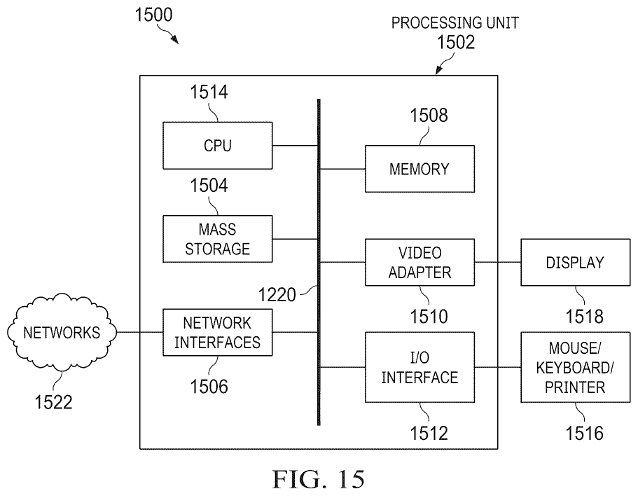

FIG. 15 is a block diagram of a computing system 1500 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1500 includes a processing unit 1502. The processing unit includes a central processing unit (CPU) 1514, memory 1508, and may further include a mass storage device 1504, a video adapter 1510, and an I/O interface 1512 connected to a bus 1520.

The bus 1520 may be one or more of any type of several bus architectures including a memory bus or memory controller, a peripheral bus, or a video bus. The CPU 1514 may comprise any type of electronic data processor. The memory 1508 may comprise any type of non-transitory system memory such as static random access memory (SRAM), dynamic random access memory (DRAM), synchronous DRAM (SDRAM), read-only memory (ROM), or a combination thereof. In an embodiment, the memory 1508 may include ROM for use at boot-up, and DRAM for program and data storage for use while executing programs.

The mass storage 1504 may comprise any type of non-transitory storage device configured to store data, programs, and other information and to make the data, programs, and other information accessible via the bus 1520. The mass storage 1504 may comprise, for example, one or more of a solid state drive, hard disk drive, a magnetic disk drive, or an optical disk drive.

The video adapter 1510 and the I/O interface 1512 provide interfaces to couple external input and output devices to the processing unit 1502. As illustrated, examples of input and output devices include a display 1518 coupled to the video adapter 1510 and a mouse, keyboard, or printer 1516 coupled to the I/O interface 1512. Other devices may be coupled to the processing unit 1502, and additional or fewer interface cards may be utilized. For example, a serial interface such as Universal Serial Bus (USB) (not shown) may be used to provide an interface for an external device.

The processing unit 1502 also includes one or more network interfaces 1506, which may comprise wired links, such as an Ethernet cable, or wireless links to access nodes or different networks. The network interfaces 1506 allow the processing unit 1502 to communicate with remote units via the networks. For example, the network interfaces 1506 may provide wireless communication via one or more transmitters/transmit antennas and one or more receivers/receive antennas. In an embodiment, the processing unit 1502 is coupled to a local-area network 1522 or a wide-area network for data processing and communications with remote devices, such as other processing units, the Internet, or remote storage facilities.

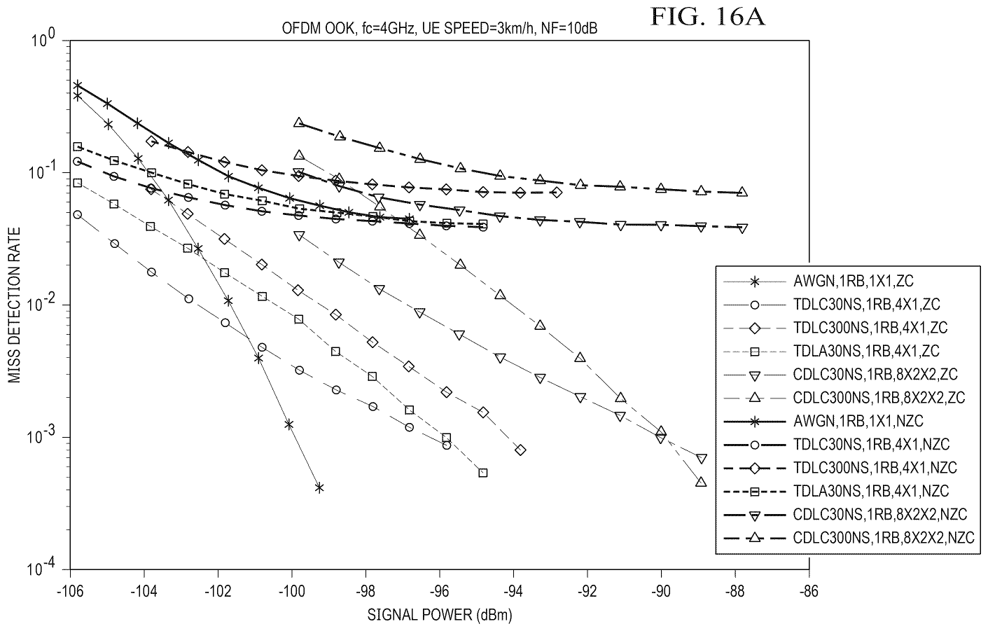

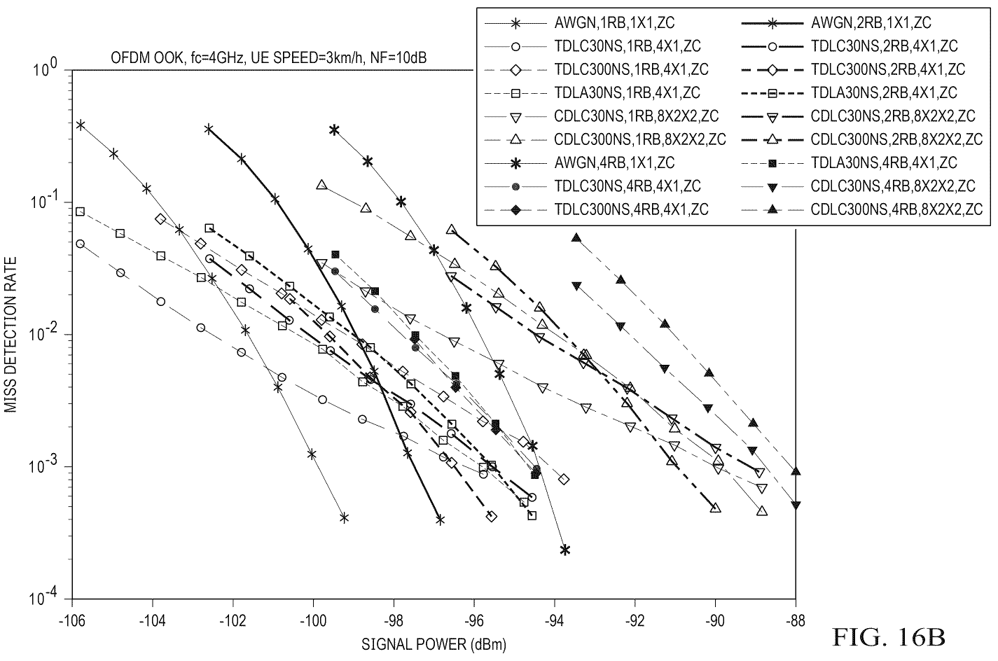

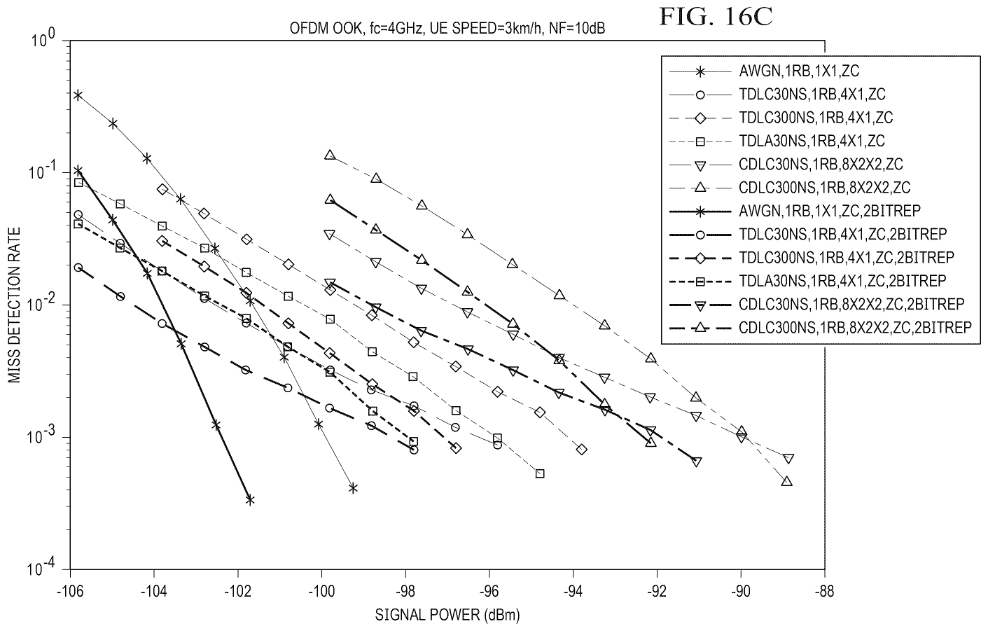

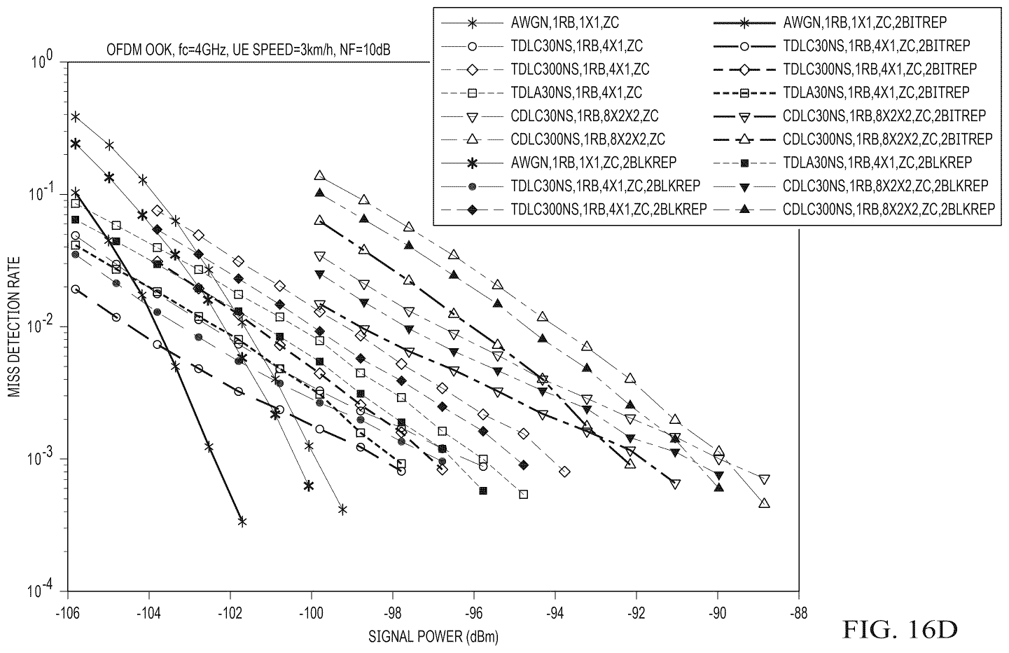

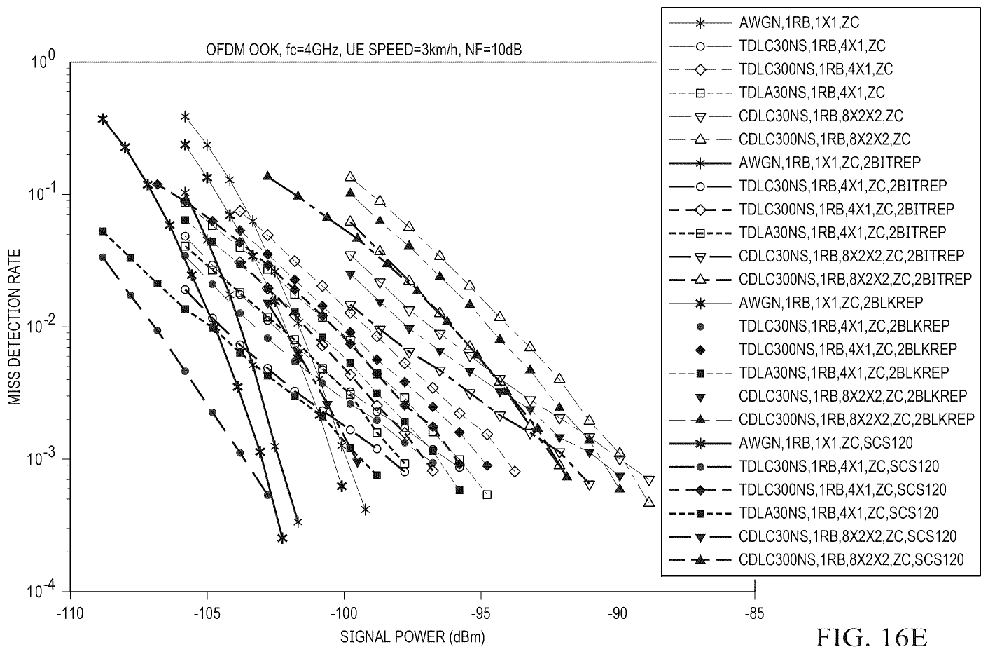

FIGS. 16A-16E illustrates wake-up signal evaluation results. FIG. 16A shows that the ZC signal in one OFDM symbol has the performance advantage. FIG. 16B shows that wider frequency transmission degrades frequency flat detection performance and wider frequency transmission improve frequency selective detection performance. In a simulation setup, a 2-RB setting may achieve the best performance. FIG. 16C shows that bit level repetition improves detection performance. FIG. 16D shows that block level repetition improves detection performance and bit level repetition is more effective than bit block level repetition for detection performance improvement. FIG. 16E shows that larger SCS improves detection performance and larger SCS is the most effective for detection performance improvement.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of this disclosure.

What is claimed is:

1. A user equipment (UE), comprising:
at least one processor; and
a non-transitory computer readable storage medium storing instructions that, when executed by the at least one processor, cause the UE to perform operations including:
receiving, using a first type of waveform, one or more configurations, the one or more configurations indicating resources allocated to wakeup signal (WUS) transmission;
receiving, using a second type of waveform, a WUS in the resources; and
performing a wakeup procedure in response to the receiving the WUS.

2. The UE of claim 1,
wherein the receiving the one or more configurations comprises receiving the one or more configurations using a first radio of the UE,
wherein the receiving the WUS comprises receiving the WUS using a second radio of the UE while the first radio of the UE is in a sleep power state, and
wherein the performing the wakeup procedure comprises performing the wakeup procedure using the first radio.

3. The UE of claim 2, the operations further comprising:
after the receiving the one or more configurations, configuring the second radio of the UE based on the one or more configurations;
transitioning, by the first radio of the UE, to the sleep power state; and
after the receiving the WUS, waking up, by the second radio of the UE, the first radio of the UE.

4. The UE of claim 2, wherein the first radio is a main radio of the UE, and the second radio is a wake-up receiver (WUR) of the UE.

5. The UE of claim 2, the sleep power state being a deep sleep state.

6. The UE of claim 1, wherein the resources include one or more WUS resource blocks (WU-RBs), and wherein the one or more configurations indicate a frequency location, a time duration, a starting position, and a periodicity for the WUS.

7. The UE of claim 6, wherein the one or more WU-RBs are in a WUS bandwidth part (WUS-BWP).

8. The UE of claim 6, wherein a first number of tones carrying the WUS is based on a second number of the one or more WU-RBs and a guard band portion of the resources.

9. The UE of claim 1, the one or more configurations further indicating at least one of a bit-level repetition number or a block-level repetition number for the WUS.

10. The UE of claim 1, the one or more configurations further indicating a subcarrier spacing (SCS) for the WUS in a carrier, the SCS being different from a second SCS used for data and control signal transmissions in the carrier.

11. The UE of claim 10, wherein the SCS is one of 60 kHz, 120 kHz, 240 kHz, 480 kHz, or 960 kHz, and wherein the resources are within frequency range 1 (FR1).

12. The UE of claim 1, the WUS being modulated by on-off keying (OOK), the one or more configurations indicating one or more sequences for shaping an on waveform for the WUS.

13. The UE of claim 12, the one or more sequences being cell specific or receiver specific.

14. The UE of claim 12, the one or more sequences being one or more Zadoff-Chu (ZC) sequences.

15. The UE of claim 1, the one or more configurations carried in a radio resource control (RRC) message or in a system information block (SIB).

16. The UE of claim 1, the operations further comprising:
transmitting, using the first type of waveform, a configuration acknowledgement acknowledging the one or more configurations.

17. The UE of claim 1, the operations further comprising:
communicating, using the first type of waveform, in response to the wakeup procedure.

18. A base station, comprising:
at least one processor; and
a non-transitory computer readable storage medium storing instructions that, when executed by the at least one processor, cause the base station to perform operations including:
transmitting, using a first type of waveform to a user equipment (UE), one or more configurations, the one or more configurations indicating resources allocated to wakeup signal (WUS) transmission;
transmitting, using a second type of waveform to the UE, a WUS in the resources, the WUS carrying an identifier that causes the UE to perform a wakeup procedure; and
transmitting a paging message to the UE while the UE is expected to be awake subsequent to the wakeup procedure.

19. The base station of claim 18, wherein the resources include one or more WUS resource blocks (WU-RBs), and wherein the one or more configurations indicate a frequency location, a time duration, a starting position, and a periodicity for the WUS.

20. The base station of claim 19, wherein the one or more WU-RBs are in a WUS bandwidth part (WUS-BWP).

21. The base station of claim 18, the one or more configurations further indicating at least one of a bit-level repetition number or a block-level repetition number for the WUS.

22. The base station of claim 18, the one or more configurations further indicating a subcarrier spacing (SCS) for the WUS in a carrier, the SCS being different from a second SCS used for data and control signal transmissions in the carrier.

23. The base station of claim 18, the WUS being modulated by on-off keying (OOK), the one or more configurations indicating one or more sequences for shaping an on waveform for the WUS.

24. The base station of claim 23, the one or more sequences being cell specific or receiver specific.

25. The base station of claim 23, the one or more sequences being one or more Zadoff-Chu (ZC) sequences.

26. A method, comprising:
receiving, by a user equipment (UE) using a first type of waveform, one or more configurations, the one or more configurations indicating resources allocated to wakeup signal (WUS) transmission;
receiving, by the UE using a second type of waveform, a WUS in the resources; and
performing, by the UE, a wakeup procedure in response to the receiving the WUS.
